(19) United States
(12) Patent Application Publication
(10) Pub. No.: US 2008/0012169 A1
(43) Pub. Date: Jan. 17, 2008

(54) Ballistic panel and method of making the same

(76) Inventors: Gregory J. Solomon, Clayton, NC (US); Greg P. Chapman, Raleigh, NC (US)

Correspondence Address: BARNES & THORNBURG LLP, 11 SOUTH MERIDIAN, INDIANAPOLIS, IN, 46204, US

(21) Appl. No.: 11/223,229

(22) Filed: Sep. 9, 2005

Related U.S. Application Data
(60) Provisional application No. 60/636,464, filed on Dec. 16, 2004.

(51) Int. Cl. B29C 70/52

(52) U.S. Cl. 264/136; 264/137; 264/145

(57) ABSTRACT

A fiber-reinforced composite ballistic panel is formed continuously. A pultrusion process may be used to form the ballistic panel in such a continuous manner.

This application claims the benefit under 35 U.S.C. § 119(e) of U.S. Provisional Application No. 60/636,464 which was filed Dec. 16, 2004 and is hereby incorporated by reference herein.

### FIELD OF THE DISCLOSURE

The present disclosure relates generally to ballistic and blast panels for use in the construction of armor.

### BACKGROUND OF THE DISCLOSURE

Armor is used to protect individuals and equipment from ballistic rounds and blast forces and shrapnel. Such armor may be embodied as a number of panels constructed of ballistic and/or blast resistant materials such as ballistic aluminum, ballistic steel, or polymer concrete.

There are a number of standards for rating the performance characteristics of armor. One such standard is UL 752, 10^{th} Edition (hereinafter “UL 752”) entitled “Bullet Resisting Equipment and published by Underwriters Laboratories Inc. of Northbrook, Ill. on Mar. 10, 2000. Another standard is NIJ Standard 0108.01 (hereinafter referred to by that name) entitled “Ballistic Resistant Protective Materials” and published by the National Institute of Justice in September 1985. Each of UL 752 and NIJ Standard 0108.01 is hereby incorporated by reference herein. The V50 Ballistic Limit Test velocity may also be indicative of the performance characteristics of the armor.

### SUMMARY OF THE DISCLOSURE

According to an aspect of the disclosure, a method comprises the step of continuously forming a fiber-reinforced composite ballistic panel that has a UL 752 rating of at least Level 1 or an NIJ Standard 0108.01 rating of at least Type I. Exemplarily, a pultrusion process may be used to form the ballistic panel in such a continuous manner. The ballistic panel may be used in the fabrication of vehicles, shelters, exterior building panels, perimeter walls, and the like.

The above and other features of the present disclosure will become apparent from the following description and the attached drawings.

### BRIEF DESCRIPTION OF THE DRAWINGS

FIG. 1 is a perspective view of a ballistic and blast panel;

FIG. 2 is a view similar to FIG. 1, but showing the metallic facing embodied as a sheet;

FIGS. 3 and 4 are cross sectional views of a ballistic and blast panel;

FIG. 5 is a fragmentary cross sectional view of another ballistic and blast panel;

FIG. 6 is a fragmentary cross sectional view of a wall construct;

FIG. 7 is a sectional view of a ballistic panel;

FIG. 8 is a diagrammatic view of a method for continuously forming the ballistic panel of FIG. 7;

FIG. 9 is a sectional view of a blast panel; and

FIG. 10 is a diagrammatic view of a method for continuously forming the blast panel of FIG. 9.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

An aspect of the present disclosure relates to ballistic and blast protection panels having a metallic facing secured to a fiber-reinforced polymer (FRP) backing panel. Such panels may be used in the construction of vehicles, perimeter walls, shelters, buildings, and the like. Generally, as shall be discussed in greater detail herein, a metallic facing is secured to an FRP panel in lieu of having the facing secured to, and fully supported by, other conventional primary structures such as steel or concrete. In certain embodiments, the metallic facing may be used in combination with a three-dimensional (3-D) FRP backing panel, although two-dimensional (2-D) panels are also contemplated.

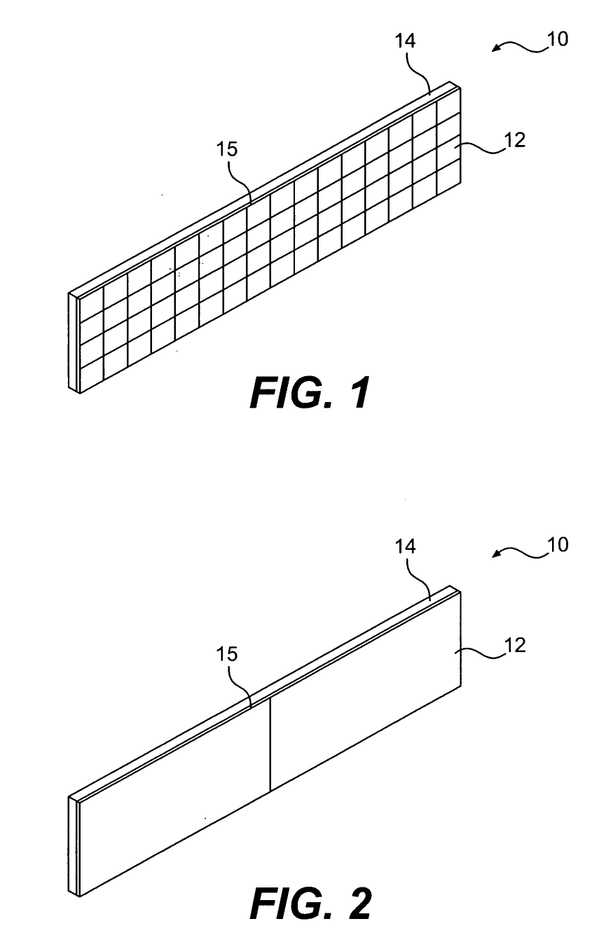

As shown in FIG. 1, a ballistic and blast panel 10 includes a metallic facing 12 secured to an FRP backing panel 14. The FRP backing panel 14 may be formed of a polymer matrix composite material which includes a reinforcing agent and a polymer resin. The FRP backing panel 14 may be embodied as any type of FRP structure. Examples of such structures include, but are not limited to, a solid laminate or a sandwich panel (e.g., a panel having upper and lower skins with a core therebetween). In certain embodiments, the FRP backing panel 14 provides the primary structural support for the metallic facing 12, although other structural support mechanisms may be used in combination with the panel 14. As alluded to above, the FRP backing panel 14 may be embodied as either a 2-D or 3-D structure (e.g., a 2-D or 3-D laminate or panel).

The matrix may include a thermosetting resin, although thermoplastic resins are also contemplated for use. Examples of thermosetting resins which may be used include, but are not limited to, unsaturated polyesters, vinyl esters, polyurethanes, epoxies, phenolics, and mixtures and blends thereof.

The reinforcing agent may include E-glass fibers, although other reinforcements such as S-glass, carbon, KEVLAR®, aramids, metal, UHMW (ultra high molecular weight) materials, high modulus organic fibers (e.g. aromatic polyamides, polybenzamidazoles, and aromatic polyimides), and other organic fibers (e.g. polyethylene and nylon) may be used. Blends and hybrids of the various reinforcing materials may be used. Other suitable composite materials may be utilized including whiskers and fibers such as boron, aluminum silicate, and basalt.

In the case of where the FRP backing panel 14 is embodied as a sandwich panel, the core type may include, but is not limited to, balsa wood, foam, open-cell material, closed-cell material, and various types of honeycomb.

The FRP backing panel 14 may be embodied as any of the structures disclosed in U.S. Pat. Nos. 5,794,402; 6,023,806; 6,044,607; 6,070,378; 6,081,955; 6,108,998; 6,467,118 B2; 6,645,333; 6,676,785, the entirety of each of which is hereby incorporated by reference. It should be appreciated that the structures disclosed in the above-identified patents may be sized, scaled, dimensioned, orientated, or otherwise configured in any desired manner to fit the needs of a given design of the FRP backing panel 14.

The metallic facing 12 may be constructed of ballistic steel, although other materials such as ballistic aluminum and other metallic facings (including both ballistic grades as well as conventional grades) are contemplated for use. One such material is Armor Gard which is commercially available from Heflin Steel of Phoenix Ariz.

Certain steels currently used by the military are documented in the following specifications: MIL-DTL-46177, MIL-A-12560, and MIL-A-46100. Although not limited to these armor steels, any material meeting any one or more of these specifications is contemplated for use in the construction of the metallic facing 12.

In addition to other sources, such armor steels may be acquired from Heflin Steel; Clifton Steel Company of Twinsburg, Ohio; Algoma Steel, Incorporated of Sault Ste. Marie, Ontario; Firth Rixson, Limited of East Hartford, Conn.; and International Steel Group Incorporated of Richfield, Ohio (formerly Bethlehem Lukens Plate).

As shown in FIG. 1, the metallic facing 12 may be embodied as tiles (including relatively small tiles). As shown in FIG. 2, the metallic facing 12 may be embodied as larger sheet sections. Other configurations are also contemplated.

Moreover, the metallic facing 12 may be embodied as more than one layer of material. For example, multiple sheets or tiles of ballistic steel may be secured the FRP backing panel 14. In one specific exemplary embodiment, the metallic facing 12 is embodied as two sheets of ballistic steel. In a further specific exemplary embodiment, the ballistic level of the two steel sheets differs from one another.

The metallic facing 12 may be secured to the FRP backing panel 14 with mechanical fasteners, adhesives, or both. Other fastening methods may also be used. The adhesive 15 may be used structurally or simply as a leveling agent for the two surfaces.

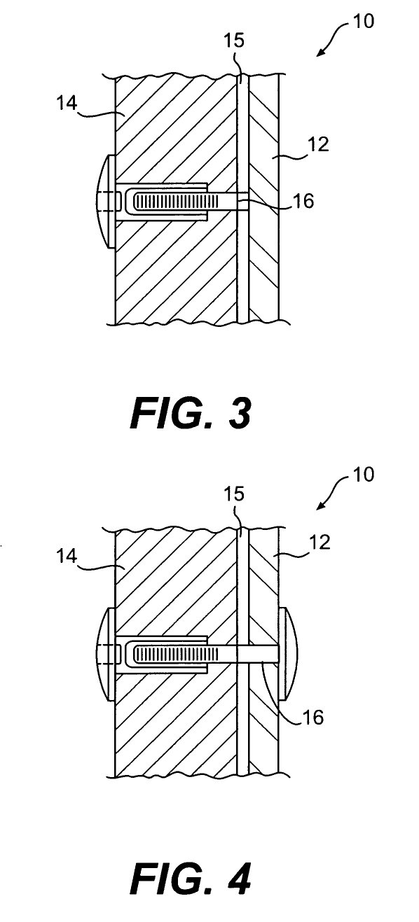

As shown in FIG. 3, a portion of the mechanical fastener 16 may be welded to metallic facing 12 and received by a corresponding portion of the fastener 16 attached to the FRP backing panel 14. Alternatively, the metallic facing 12 may include a number of holes through which a portion of the mechanical fastener is extended.

As shown in FIG. 4, according to another embodiment of the mechanical fastener 16, corresponding portions of the mechanical fastener 16 extend through the metallic facing 12 and the FRP backing panel 14, respectively, and are bolted to one another.

It should be appreciated that in addition to metallic facing, other types of armor facing material may also be used. For example, ceramics may be used. Ceramics are particularly well suited for lightweight applications. Exemplary ceramics for such use are available from Ceradyne, Incorporated of Costa Mesa, Calif. and CoorsTek, Incorporated of Golden, Colo. Moreover, other types of non-metallic armor facing materials may also be used. For example, the armor facing may be constructed with granite tiles, marble tiles, or polymer concrete.

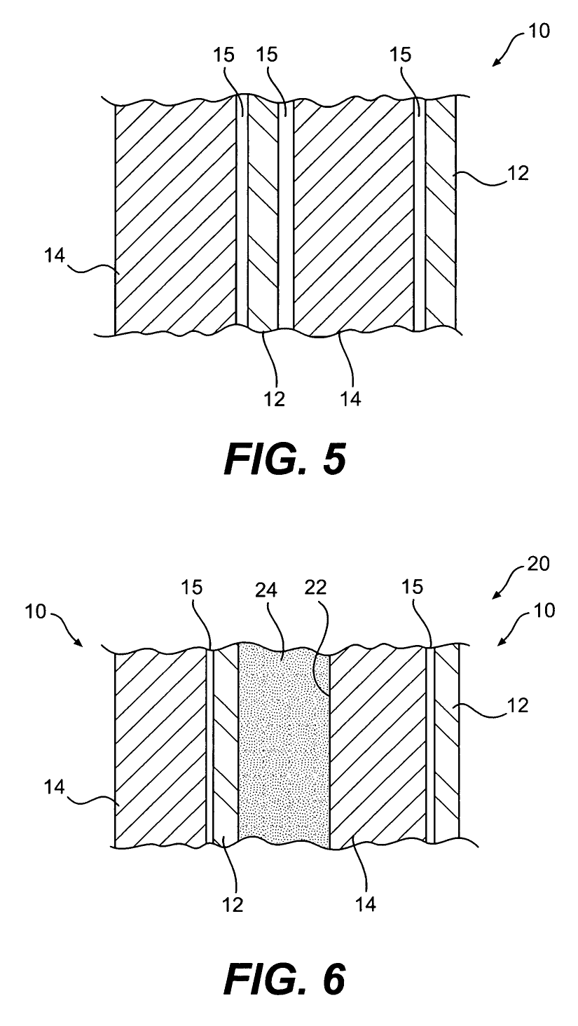

It should be appreciated that a ballistic and blast panel 10 having a plurality of metallic facings 12 and/or FRP backing panels 14 may be constructed. For example, as shown in FIG. 5, a ballistic and blast panel 10 may be constructed which includes a first metallic facing 12 (having one or more layers of ballistic steel) secured to a first FRP backing panel 14 which is also secured to a second metallic facing 12 (having one or more layers of ballistic steel) which is in turn secured to a second FRP backing panel 14. In other words, a panel construct may be designed which includes two of the panels 10 shown in FIG. 2 secured to one another in a manner in which the metallic facing 12 of one of the panels is secured to the FRP backing panel 14 of the other panel.

Along a similar line, a wall construct 20 may be designed in which two of the panels 10 are spaced apart from one another in a manner which creates a cavity 22 or other type of void therebetween (see FIG. 6). Such a cavity 22 may be filled with a ballistic resistant filler material 24 such as sand, ball bearings, scrap metal, or the like.

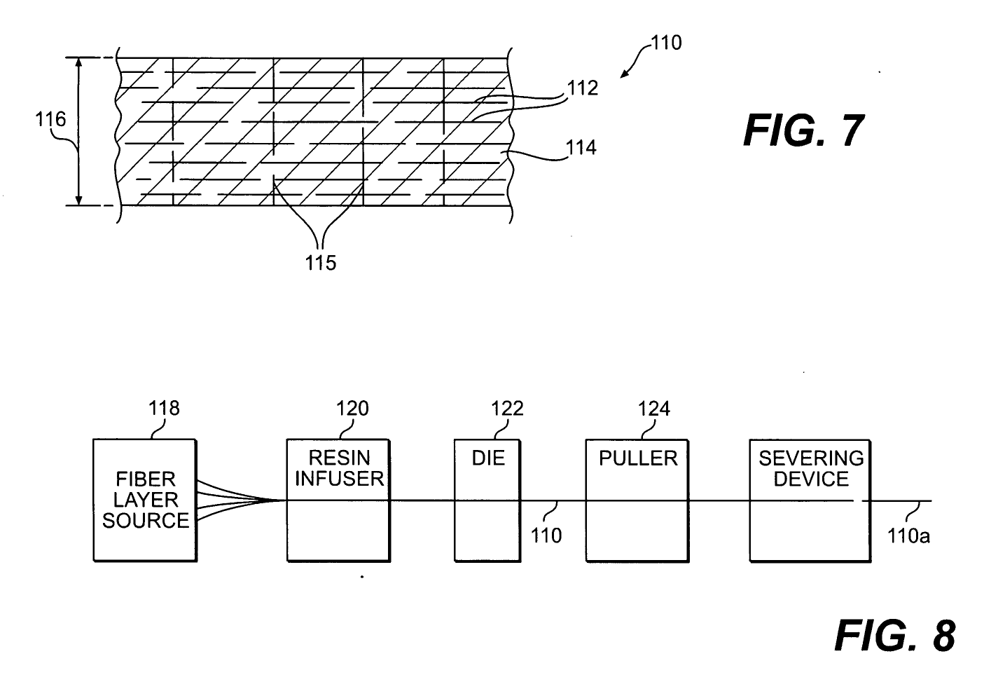

A fiber-reinforced composite ballistic panel 110 shown in FIG. 7 may be formed continuously by use of a method shown in FIG. 8. The ballistic panel 110 is designed to resist penetration of ballistic rounds, shrapnel, and other impacts.

Illustratively, the ballistic panel 110 is embodied as a solid laminate having a reinforcing agent in the form of a plurality of fiber layers 112 contained in a polymer matrix 114. The fiber layers 112 may be made of any of the reinforcing agents discussed herein and the matrix 114 may be made of any of the matrix materials discussed herein. The solid laminate may or may not have fiber insertions 115 extending through the layers 112 in a generally perpendicular manner relative thereto. The panel 110 may be formed with or without a metallic facing. The panel 110 may have any suitable thickness 116. For example, the thickness 116 may be between about ¼ inch and about 2 inches (e.g., ½ inch). Further, the panel 110 may have any suitable weight. For example, the weight of the panel 110 may be between about 2½ pounds per square foot and about 6 pounds per square foot (e.g., 5 pounds per square foot).

As mentioned above, the ballistic panel 110 is capable of withstanding a variety of impacts including, but not limited to, ballistic rounds and shrapnel (e.g., from 120 mm mortar rounds). Exemplarily, the panel 110 may be constructed so as to have a UL 752 rating of at least Level 1 or even at least Level 3 or may be constructed so as to have an NIJ Standard 0108.01 rating of at least Type I or even at least Type III-A. The panel 110 may further be constructed to have a V50 Ballistic Limit Test velocity of at least about 1511 feet per second.

According to a non-limiting example of the panel 110, the panel 110 has a UL 752 rating of Level 3, an NIJ Standard 0108.01 rating of Type III-A, and a V50 Ballistic Limit Test velocity of about 1511 feet per second. In such a case, the panel 110 has have 24 layers of 24 ounce/yd² E-glass woven roving embedded in a vinyl ester matrix, has a thickness 116 of about a ½ inch, and weighs about 5 pounds per square foot. The exemplary panel 110 is further formed without fiber insertions and without a metallic facing. The panel 110 may just as well include fiber insertions and/or a metallic facing to increase the ballistic resistance of the panel 110. Further, multiple panels 110 may be secured to one another in face-to-face relation by use of adhesive, mechanical fasteners, or other securement means to increase the ballistic resistance of the overall unit.

An illustrative method of continuously forming the ballistic panel 110 is shown in FIG. 8. The plurality of fiber layers 112 are supplied by a fiber layer source 118 (e.g., a plurality of rolls of woven roving, each roll providing one of the layers). The layers 112 may be stacked one on top of the other either upstream or downstream of a resin infuser 120. In either case, the resin infuser 120 infuses with resin the plurality of fiber layers 112 fed by the source 118. Exemplarily, the resin infuser 120 is a resin bath in which the layers 112 are dipped to fill their voids with resin as the layers 112 move toward a heated die 122. At the die 122, the resin is cured, thereby producing the panel 110. A puller 124 (e.g., a pair of alternately operating grippers and/or cooperating rollers) may be used to continuously pull the panel 110 downstream. In such a case, the method is a pultrusion process. Next, a severing device 126 severs the panel 110 at predetermined increments (e.g., every 4 feet) to produce separate portions 110a of the panel 110, each having a predetermined size (e.g., 4′×8′×½″). In the case where the panel is to have fiber insertions 115, a fiber inserter (not shown) may be included either between the source 118 and the infuser 120 and/or between the infuser 120 and the die 122.

The panel 110 may thus be formed in a continuous manner. It is to be understood that such continuous formation of the panel 110 is different from batch methods of panel production wherein one panel is produced at a time. The continuous formation method thus allows for faster production of the panel 110.

The panel 110 may be formed continuously at a desired rate (e.g., at least 1, 4, 8, or 12 inch(es) per minute). Exemplarily, the panel 110 is produced at 8 inches per minute.

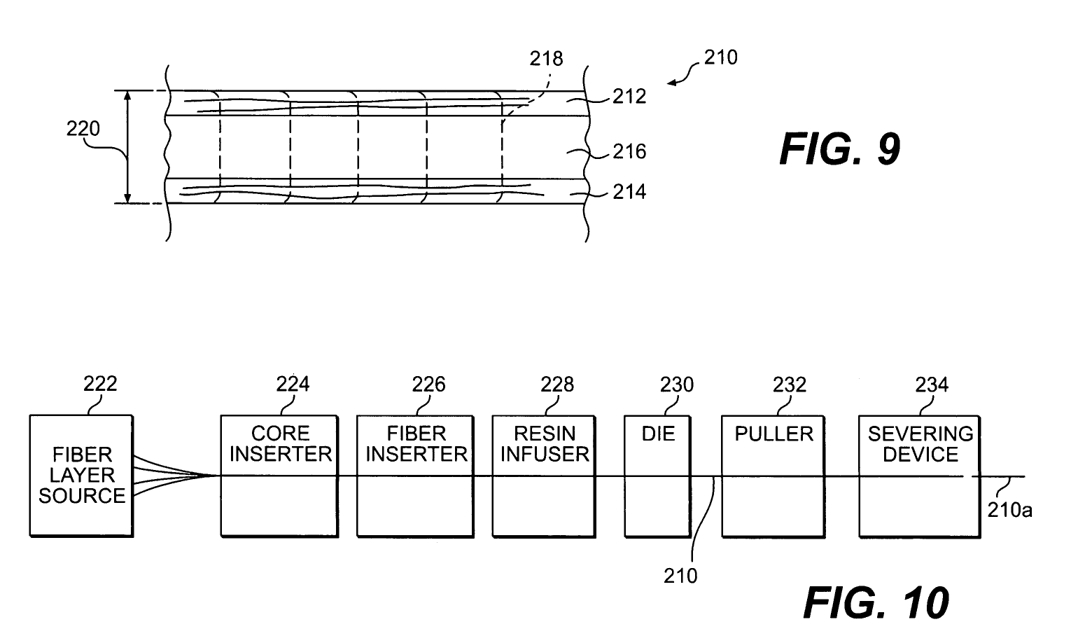

A fiber-reinforced composite blast panel 210 shown in FIG. 9 may be formed continuously by use of a method shown in FIG. 10. The blast panel 210 is designed to withstand relatively high blast pressures as discussed in more detail below.

Illustratively, the blast panel 210 is embodied as a sandwich panel having first and second skins 212, 214 and a core 216 sandwiched therebetween. In addition, the blast panel 210 may have a plurality of fiber insertions 216 extending from the first skin 212 through the core 216 to the second skin 214. The blast panel 210 may or may not include a metallic facing secured to the sandwich panel according to any of the securement methods disclosed herein.

Exemplarily, each skin 212, 214 is an FRP solid laminate having a plurality of fiber layers made of any reinforcing agent disclosed herein including, but not limited to, woven roving made of E-glass, S-glass, carbon, UHMW materials, polyethylene, aramids, nylon, and/or KEVLAR®, to name just a few. The woven roving may weigh about 77 ounces per square yard or more or less than 77 ounces per square yard such as about 96 ounces per square yard. The woven roving is embedded in a polymer matrix made of any matrix material disclosed herein, such as vinyl ester, polyester, or any other resin. Further, the core may be made of any of the core types disclosed herein including, but not limited to, open-celled or closed-celled urethane foam weighing between about 2 and about 3 pounds per cubic foot. The density of the fiber insertions 216 may be at least 1 insertion per square inch, such as 2 insertions per square inch.

The panel 210 may have any suitable thickness 220. For example, the thickness 220 may be less than about 4 inches, 3 inches, or 2 inches, depending on the blast forces to be resisted. Exemplarily, the thickness 220 is about 2 inches. In such a case, each skin 212, 214 may have a thickness of about a ½ inch and the core 216 may have a thickness of about 1 inch.

Further, the panel 210 may have any suitable weight. For example, the panel 210 may weigh less than about 10 pounds per square foot, such as about 9 pounds per square foot or even only about 7.2 pounds per square foot with the use of lighter materials such as S-glass, KEVLAR®, or other high-performance fiber.

According to one particular exemplary implementation of the blast panel 210, the skins 212, 214 are made of 6 layers of 77 ounce/yd² E-glass woven roving embedded in vinyl ester matrix. The core 216 is made of urethane foam weighing about 2-3 pounds per square foot. The thickness 220 is about 2 inches, each skin 212, 214 having a thickness of about a ½ inch and the core 216 having a thickness of about 1 inch. Fiber insertions 218 extend from the skin 212 through the core 216 to the skin 214. The panel 210 is formed without metal. As such, it has no metallic facing. The weight of the panel 210 is about 9 pounds per square foot.

This particular exemplary implementation was subjected to blast testing. In a first blast test, a 4′×4′ sample of the exemplary panel implementation was mounted in a steel frame and a 5-pound charge of C4 material was placed three feet away from the sample. The C4 charge was exploded and the peak incident overpressure and the normally reflected pressure were measured at 349.3 psi and 2436 psi, respectively. In a second blast test, a 4′×4′ sample of the exemplary panel implementation was mounted in the a steel frame and a 5-pound charge of C4 material was placed six feet away from the sample. The C4 charge was exploded and the peak incident overpressure and the normally reflected pressure were measured at 77.42 psi and 349.2 psi, respectively.

An illustrative method of continuously forming the blast panel 210 is shown in FIG. 10. A plurality of fiber layers are supplied by a fiber layer source 222 (e.g., a plurality of rolls of woven roving, each roll providing one of the layers) to provide the layers for each skin 212, 214. The layers of each skin 212, 214 are stacked one on top of the other and the core 216 is inserted between the skins 212, 214 by a core inserter 224 to form a dry sandwich. The fibers 218 are then inserted through the dry sandwich by a fiber inserter 226. The dry sandwich with fiber insertions is then infused with resin by a resin infuser 228 (e.g., resin bath) after which the wetted unit is passed through a heated die 230 to cure the wetted unit, thereby forming the blast panel 210. A puller 232 (e.g., a pair of alternately operating grippers and/or cooperating rollers) may be used to continuously pull the panel 210 downstream. In such a case, the method is a pultrusion process. Next, a severing device 234 severs the panel 210 at predetermined increments (e.g., every 4 feet) to produce separate portions 210a of the panel 210, each having a predetermined size (e.g., 4′×8′×½″). The panel 210 may thus be formed in a continuous manner at a desired rate.

Each of the continuous panel formation methods described in connection with FIGS. 8 and 10 may include means for restricting resin flow onto the dry unit. In this way, the distribution of the resin (e.g., uniform distribution) and the overall weight of the panel can be controlled. Exemplarily, the die itself may provide the resin restriction device. In other words, as the uncured panel is advanced through the die, the die may remove excess resin to provide the panel with a desired shape. Other means may be used for restricting resin flow. For example, the amount of resin per unit length to be deposited onto the dry unit may be determined for a given rate at which the panel is formed. A controller receiving the rate as in input may be used to control operation of a resin infuser to deposit the corresponding desired amount of resin per unit length. If the panel formation rate is increased or decreased, the controller may correspondingly adjust operation of the resin infuser to increase or decrease the resin deposition rate.

While the concepts of the present disclosure have been illustrated and described in detail in the drawings and foregoing description, such illustration and description is to be considered as exemplary and not restrictive in character, it being understood that only illustrative embodiments have been shown and described and that all changes and modifications that come within the spirit of the disclosure are desired to be protected.

There are a plurality of advantages of the concepts of the present disclosure arising from the various features of the systems described herein. It will be noted that alternative embodiments of each of the systems of the present disclosure may not include all of the features described yet still benefit from at least some of the advantages of such features. Those of ordinary skill in the art may readily devise their own implementations of a system that incorporate one or more of the features of the present disclosure and fall within the spirit and scope of the invention as defined by the appended claims.

1. A method comprising the step of continuously forming a fiber-reinforced composite ballistic panel that has a UL 752 rating of at least Level 1 or an NIJ Standard 0108.01 rating of at least Type I.

2. The method of claim 1, wherein the forming step comprises pultruding the ballistic panel.

3. The method of claim 1, wherein the forming step comprises continuously feeding a plurality of fiber layers, infusing the plurality of fiber layers with resin, curing the resin-infused fiber layers to form the ballistic panel, and severing the ballistic panel to provide a portion separate therefrom.

4. The method of claim 3, wherein the feeding step comprises continuously feeding about 24 layers of woven roving, each layer having a weight of about 24 ounces per square yard.

5. The method of claim 1, wherein the forming step comprises continuously forming the ballistic panel at a rate of at least one inch per minute.

6. The method of claim 1, wherein the forming step comprises continuously forming the ballistic panel at a rate of at least four inches per minute.

7. The method of claim 1, wherein the forming step comprises continuously forming the ballistic panel at a rate of at least 8 inches per minute.

8. The method of claim 1, wherein the forming step comprises continuously forming the ballistic panel at a rate of at least 12 inches per minute.

9. The method of claim 1, wherein the forming step comprises continuously forming the ballistic panel at a rate of about 8 inches per minute.

10. The method of claim 1, wherein the forming step comprises continuously forming the ballistic panel so as to have a weight between about 2½ pounds per square foot and about 6 pounds per square foot.

11. The method of claim 1, wherein the forming step comprises continuously forming the ballistic panel so as to have a weight of about 5 pounds per square foot.

12. The method of claim 1, wherein the forming step comprises continuously forming the ballistic panel so as to have a thickness between about ¼ inch and about 2 inches.

13. The method of claim 1, wherein the forming step comprises continuously forming the ballistic panel so as to have a thickness of about ½ inch.

14. The method of claim 1, wherein the forming step comprises continuously forming the ballistic panel as a solid laminate.

15. The method of claim 1, wherein the forming step comprises continuously forming the ballistic panel so as to have a UL 752 rating of at least Level 3.

16. The method of claim 1, wherein the forming step comprises continuously forming the ballistic panel so as to have an NIJ Standard 0108.01 rating of at least Type III-A.

17. The method of claim 1, wherein the forming step comprises continuously forming the ballistic panel so as to have a V50 Ballistic Limit Test velocity of at least about 1511 feet per second.
